(19) United States
(12) Patent Application Publication
(10) Pub. No.: US 2024/0406139 A1
(43) Pub. Date: Dec. 5, 2024

(54) EDGE DATA FILTER

(71) Applicant: Bank of America Corporation, Charlotte, NC (US)

(72) Inventors: Jayachandra Varma, Irvington, TX (US); Manu Kurian, Dallas, TX (US)

(21) Appl. No.: 18/202,997

(22) Filed: May 29, 2023

(51) Int. Cl. H04L 9/40

(52) U.S. Cl. CPC H04L 63/0236

(57) ABSTRACT

Apparatus and methods to automatically filter data at an edge of a network are provided. An edge data filter may intercept incoming data before the data is downloaded onto the network. The edge data filter may analyze the data and metadata of the data through one or more artificial intelligence/machine learning (“AI/ML”) algorithms to determine if any of the data is relevant to the network. When any of the data is relevant to the network, the edge data filter may release the relevant data to the network.

### FIELD OF TECHNOLOGY

Aspects of the disclosure relate to providing apparatus and methods to automatically filter data at an edge of a network.

### BACKGROUND OF THE DISCLOSURE

Entities may include individuals, corporations, partnerships, non-profits, government agencies or branches, and other groups of people. Entities may be any size, including small (one member or employee) or large (thousands of employees or members). Entities may have an internal network. Entities may have one or more units of computer equipment, including servers, personal computers, and mobile computing devices.

Entities may receive large amounts of data every day. This amount of data may increase over time. Entities may need to or desire to evaluate this data for various reasons, including regulations, business decisions, marketing, compliance, security, safety, malicious activity, and other analyses.

However, not all of the data may be relevant for each particular analysis or evaluation.

For example, a financial institution may need to evaluate certain data for “know your customer” (“KYC”) anti-money laundering requirements, but other data may be irrelevant for this analysis. The financial institution may have a dedicated network or computer system/cluster to evaluate KYC data, while other computers may be used for other analyses. It would be inefficient and a waste of resources for the KYC network to receive all of the incoming data when it only needs some of the data.

Currently there is no apparatus or method to filter all of the incoming data at an edge of a network, before the network receives all of the incoming data.

Therefore, it would be desirable for apparatus and methods to filter incoming data at an edge of a network.

### SUMMARY OF THE DISCLOSURE

It is an object of this disclosure to provide apparatus and methods to automatically filter incoming data at an edge of a network.

An edge data filter computer program product is provided. The computer program product may include executable instructions. The executable instructions may be stored in non-transitory memory and be executed by a processor on a computer system.

When the executable instructions are executed by a processor on a computer system, they may intercept incoming data before the incoming data is downloaded by a network. The incoming data may include two or more quanta of data.

The instructions may analyze the incoming data and metadata of the incoming data to determine when one or more quanta of the incoming data is relevant to the network.

When one or more quanta of data is relevant to the network, the instructions may release the one or more quanta of data that is relevant to the network, allowing the network to download the relevant data.

The instructions may apply one or more artificial intelligence/machine learning (“AI/ML”) algorithms in their analysis to determine whether the incoming data is relevant to the network.

In an embodiment, the instructions may store the incoming data in a safe zone.

In an embodiment, the safe zone may be outside of the network.

In an embodiment, the analysis may analyze a geographic origin of the incoming data.

In an embodiment, the analysis may analyze an originating time of the incoming data.

In an embodiment, the analysis may analyze a personal origin of the incoming data.

In an embodiment, the analysis may analyze a type of the incoming data.

In an embodiment, the analysis may compare the incoming data to data already on the network.

In an embodiment, the analysis may apply one or more filtering rules to determine whether the incoming data is relevant to the network. In an embodiment, the one or more filtering rules may be supplied by an administrator.

In an embodiment, the instructions may be trained with a training set of data.

In an embodiment, the analysis may iterate when intercepting additional incoming data.

In an embodiment, the analysis may analyze metadata of the incoming data to determine when one or more quanta of the incoming data is relevant to two or more networks.

In an embodiment, when one or more quanta of data is relevant to one or more of the two or more networks, the instructions may release the one or more relevant quanta of data to the one or more of the two or more networks.

In an embodiment, the instructions may route relevant one or more quanta of data to each network of the one or more networks.

In an embodiment, the instructions may be configured to store all of the incoming data in a database.

In an embodiment, the network may be an internal network.

In an embodiment, the internal network may be configured to perform an evaluation of data received by the internal network, after it has passed through the edge data filter.

In an embodiment, the safe zone may be part of the network but may be isolated from a remaining portion of the network.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic in accordance with principles of the disclosure.

FIG. 4 shows an illustrative schematic in accordance with principles of the disclosure.

FIG. 5 shows an illustrative flowchart in accordance with principles of the disclosure.

FIG. 6 shows an illustrative apparatus in accordance with principles of the disclosure.

### DETAILED DESCRIPTION OF THE DISCLOSURE

It is an object of this disclosure to provide apparatus and methods to automatically filter incoming data at an edge of a network.

An edge data filter computer program product is provided. The computer program product may include executable instructions. The executable instructions may be stored in non-transitory memory and be executed by a processor on a computer system.

Multiple processors may increase the speed and capability of the program. The executable instructions may be stored in non-transitory memory on the computer system or a remote computer system, such as a server.

Other standard components of a computer system may be present. The computer system may be a server, mobile device, or other type of computer system. A server or more powerful computer may increase the speed at which the computer program may run. Portable computing devices, such as a smartphone, laptop or tablet, may increase the portability and usability of the computer program, but may not be as secure or as powerful as a server or desktop computer.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The computer may include, among other components, a communication link, a processor or processors, and a non-transitory memory configured to store executable data configured to run on the processor. The executable data may include an operating system and the edge data filter program.

A processor or processors may control the operation of the computer system and its components, which may include RAM, ROM, an input/output module, and other memory. The microprocessor(s) may also execute all software running on the apparatus and computer system. Other components commonly used for computers, such as EEPROM or Flash memory or any other suitable components, may also be part of the apparatus and computer system.

A communication link may enable communication with other computers as well as any server or servers. The communication link may include any necessary hardware (e.g., antennae) and software to control the link. Any appropriate communication link may be used, such as Wi-Fi, bluetooth, LAN, and cellular links. In an embodiment, the network used may be the Internet. In another embodiment, the network may be an internal intranet or other network.

The computer system may be a server. The computer program may be run on a smart mobile device. The computer program, or portions of the computer program may be linked to other computers or servers running the computer program. The server or servers may be centralized or distributed. Centralized servers may be more powerful and secure than distributed servers but may also be more expensive and less resilient.

The computer system with the edge data filter may be a part of a network. The computer system with the edge data filter may be outside of a network, but able to communicate with the network. The computer system with the edge data filter may be positioned on a network location/computer cluster map so that all incoming data to the network/computer cluster may be routed to first go to the computer system for evaluation by the filter.

When the executable instructions are executed by a processor on a computer system, they may intercept incoming data before the incoming data is downloaded by a computer system on a network. The incoming data may include two or more quanta of data. The incoming data may be transmitted from outside the network, or from a different part of the network. The network may be the internet or an internal intranet.

In an embodiment, when a computer system on a network triggers a download or is set to download data, the computer system may notify the edge data filter computer program. When the edge data filter program receives the notification, the edge data filter may intercept the data before the computer system downloads the data.

In an embodiment, the edge data filter program may be continuously active. All incoming data to the network may be routed to pass through the edge data filter before reaching the network.

In an embodiment, some particular types of data may be routed to pass through the edge data filter before reaching the network. For example, only large data files of a specific type may be routed through the edge data filter, while normal network traffic (pings, status requests, emails, texts, etc.) may go directly to the network. The particular types of data may be predetermined. The particular types of data may be determined by the edge data filter. The particular types of data may be determined by the edge data filter based on an analysis of the purpose(s) and contents of the network.

In an embodiment, the edge data filter program may be intermittently active in that it may be turned on and off at particular, pre-determined times. For example, if an entity knows that it may receive a large data dump (e.g., from multiple branches) at around the same time every day, it may turn on the edge data filter slightly before the large data dump is due, and turn it off after it was received. This may prevent the edge data filter from intercepting normal network traffic and speed up communications across the network.

The instructions may analyze the incoming data and metadata of the incoming data to determine when one or more quanta of the incoming data is relevant to the network. The instructions may apply one or more artificial intelligence/machine learning (“AI/ML”) algorithms in their analysis to determine whether the incoming data is relevant to the network.

Any suitable AI/ML algorithms may be used. Each algorithm may dynamically evaluate one or more factors in its analysis. The algorithm(s) may iterate. The algorithm(s) may be trained on a training set of data. The training set may be created data or actual data. The algorithms may be checked by one or more system administrators.

The instructions may analyze all of the incoming data and metadata. The analysis may include evaluating origin source, type of data, contents of the data, file type(s), an analysis of the network and the network's needs, as well as other factors.

Each factor may be analyzed on a scale. The scale may be of any type. For example, the scale may be a number from 0 through 10, with 10 being most likely to be relevant and 0 being least likely to be relevant to the network. The scale may be adjusted dynamically by the program. The scale may be adjusted manually.

Incoming data may be relevant to the network if it is data that the network may use or store to perform its functions. For example, a network may be configured to analyze and store mortgage applications. Relevant incoming data may be mortgage applications, credit reports, and underwriting reports. In this example, irrelevant incoming data may be stock analysis or know-your-customer reports. Relevant data may depend on the network and its purpose(s). The relevant data may change from network to network, or over time.

When one or more quanta of data is relevant to the network, the instructions may release the one or more quanta of data that is relevant to the network, allowing the network to download the relevant data. For example, if fifty documents out of the 2000 documents in the intercepted data are relevant to the network, the program may release the fifty documents.

In an embodiment, the instructions may store the incoming data in a safe zone. The safe zone may be a database, or a portion of a database. The safe zone may be unavailable to any system on the network other than the edge data filter. The safe zone may be physically walled off from other parts of the network. The safe zone may be walled off through a computer program from other parts of the network.

In an embodiment, the database may be distributed across multiple computer systems or servers. The distributed systems or servers may be geographically distant.

In an embodiment, the database may be encrypted. Encrypting the database may be required depending on the sensitivity of the data, network, or computer systems. Any appropriate encryption protocol or method may be used.

The safe zone may be encrypted. The safe zone may prevent malicious activity and files from accessing the network.

In an embodiment, the safe zone may be outside of the network. The safe zone may not be directly connected to the network. For example, in order to move information or data from the safe zone to the network, the information or data may be required to be routed through the edge data filter or another computer system or program.

In an embodiment, the safe zone may be part of the network but may be isolated from a remaining portion of the network. The isolation may be software and/or hardware based. For example. The safe zone may be on a different hard drive than the rest of the network. Or the safe zone may be a partitioned sector of a hard drive.

In an embodiment, the analysis may analyze a geographic origin of the incoming data. For example, the network may only be interested in data from the eastern seaboard of the United States. The analysis may analyze the origin of the data and determine that incoming data from California is irrelevant to the network.

In an embodiment, the analysis may analyze an originating time of the incoming data. For example, the network may only be interested in or use data from a particular time period (of the day, of the week, of the month, of the year, etc.). Any incoming data outside of that particular time period may be determined to be irrelevant.

In an embodiment, the analysis may analyze a personal origin of the incoming data. For example, the network may only be interested in data from particular individuals or entities. Any incoming data from other individuals or entities may be determined to be irrelevant data.

In an embodiment, the analysis may analyze a type of the incoming data. For example, the network may only be interested in a particular data format (.pdf, .json, etc.). Any data in a different format may be determined to be irrelevant to the network.

In an embodiment, the analysis may compare the incoming data to data already on the network. For example, if the program is unsure as to what data may be relevant to the network, the program may analyze the data already on the network. It may then compare the incoming data to the existing data. It may determine that similar data (types, contents, etc.) may be relevant, but other data may be irrelevant.

In an embodiment, the analysis may apply one or more filtering rules to determine whether the incoming data is relevant to the network. These filtering rules may be static. The filtering rules may be dynamic. The filtering rules may be adjusted automatically by the program. The filtering rules may include type of data, contents of data, origin of data, metadata, and other rules.

In an embodiment, the one or more filtering rules may be supplied by an administrator. The administrator may set each rule manually or through another program. In an embodiment, even rules supplied by an administrator may be adjusted automatically by the program, as the program learns which data is relevant or irrelevant to a particular network or computer system.

In an embodiment, the instructions may be trained with a training set of data. The more data provided to the AI/ML algorithms, the more accurate the algorithms may be. The training set of data may be annotated. The training set of data may be curated.

In an embodiment, the analysis may iterate when intercepting additional incoming data. The program may automatically learn and adjust as it iterates through additional data. The program may be configured to become more accurate in its determination of relevancy over time.

In an embodiment, the analysis may analyze the contents and metadata of the incoming data to determine when one or more quanta of the incoming data is relevant to two or more networks. In this embodiment, the filter may be analyzing and filtering data for two or more networks at one time. A more powerful computer or server may be necessary to filter data for two or more networks at the same time.

In an embodiment, when one or more quanta of data is relevant to one or more of the two or more networks, the instructions may release the one or more relevant quanta of data to the one or more of the two or more networks. As the data may only be relevant to one network, the data may release only to that network.

In an embodiment, the instructions may route relevant one or more quanta of data to each network of the one or more networks. The program may route data to a corresponding appropriate network, where the data may be relevant.

In an embodiment, the instructions may be configured to store all of the incoming data in a database.

In an embodiment, the database may be distributed across multiple computer systems or servers. The distributed systems or servers may be geographically distant.

In an embodiment, the database may be encrypted. Encrypting the database may be required depending on the sensitivity of the network or computer systems. Any appropriate encryption protocol or method may be used.

In an embodiment, the network may be an internal network. Incoming data may be from outside the internal network. Outside the internal network may include the Internet or a different internal network.

In an embodiment, the internal network may be configured to perform an evaluation of data received by the internal network after it has passed through the edge data filter. This evaluation may be a part of the network's purposes. For example, the network may be tasked to evaluate loan applications. By only receiving data relevant to loan applications, the network may then evaluate that data to complete its loan evaluation tasks.

In addition, an evaluation may be directed back to the edge data filter to refine its filtering algorithm(s). For example, the evaluation by the network may determine that data A, B, and C released by the filter are relevant, but data D and E released by the filter are not relevant. This evaluation may be transmitted back to the edge data filter to refine its filtering algorithms. The next time the edge data filter intercepts data similar to data D and E, it may determine that this data is not relevant.

An apparatus for an edge data filter is provided. The apparatus may include a central server and one or more network nodes.

The central server may include a server communication link, a server processor, and a server non-transitory memory. The server non-transitory memory may be configured to store at least a server operating system and an edge data filter.

Each network node may include a node communication link, a node processor, and a node non-transitory memory. The node non-transitory memory may be configured to store at least a node operating system.

The edge data filter application may intercept incoming data before the incoming data is downloaded by any of the one or more network nodes.

The edge data filter may analyze, by applying one or more artificial intelligence/machine learning (“AI/ML”) algorithms, metadata of the incoming data to determine when one or more quanta of the incoming data is relevant to one or more network nodes.

When one or more quanta of data is relevant to one or more network nodes, the edge data filter may release the one or more quanta of data that is relevant to the one or more network nodes.

A method for an edge data filter is provided. The method may include the step of intercepting, by an edge data filter program on a central server, incoming data before the incoming data is downloaded by a computer system on a network. The incoming data may include two or more quanta of data.

The method may include the step of analyzing, by the edge data filter program applying one or more artificial intelligence/machine learning (“AI/ML”) algorithms, the contents and metadata of the incoming data to determine when one or more quanta of the incoming data is relevant to computer system.

When one or more quanta of data is relevant to the computer system, the method may include the step pf releasing the one or more quanta of data that is relevant to the computer system.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

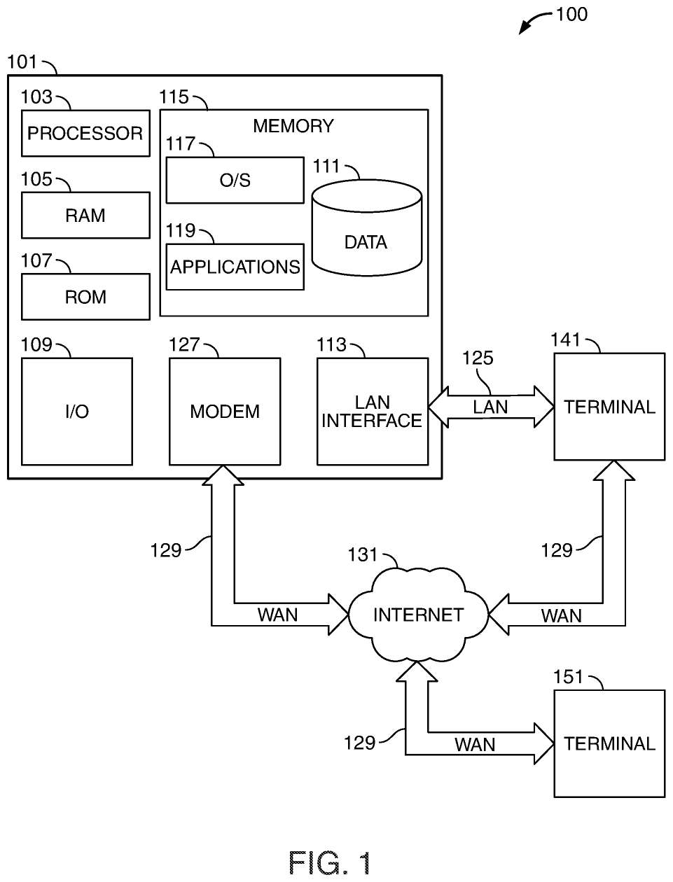

In accordance with principles of the disclosure, FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as an edge data filter and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as an edge data filter and security protocols) along with any other data 111 (e.g., historical data, configuration file) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) (such as an edge data filter and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an edge data filter and security protocols, as well as other programs. In an embodiment, one or more programs, or aspects of a program, may use one or more AI/ML algorithm(s). The various tasks may be related to filtering large amounts of data before the data is downloaded by a computer system on a network.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other Computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

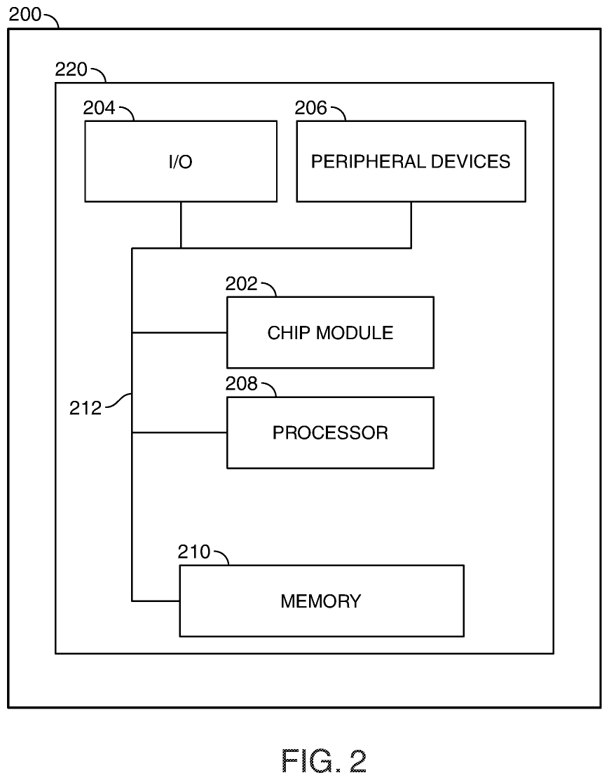

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

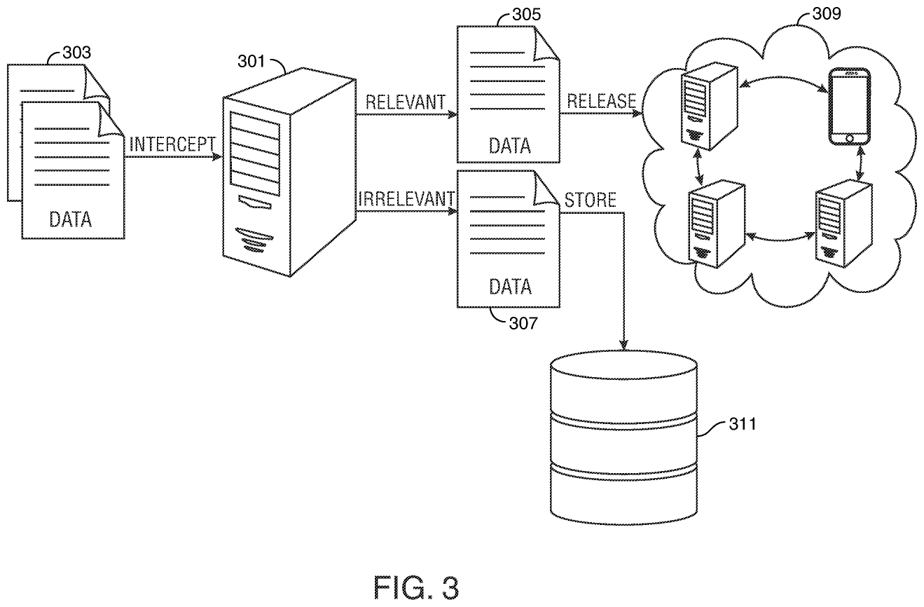

FIG. 3 shows an illustrative schematic in accordance with principles of the disclosure. Apparatus may include any of the components and systems odd-numbered 301 through 311, among other components, as well as steps labeled on FIG. 3. Steps may be performed on the apparatus shown in FIGS. 1-4, and 6 or other apparatus shown in other figures or described elsewhere

A computer system 301 on an edge of a network 309 may have an edge data filter installed. The edge data filter may intercept incoming data 303 before it reaches network 309.

The edge data filter on computer system 301 may analyze the incoming data 303 to determine which, if any, of the incoming data 303 is relevant to the network 309.

The edge data filter may release relevant data 305 to the network 309.

The edge data filter may store irrelevant data 307 in a database 311 or elsewhere.

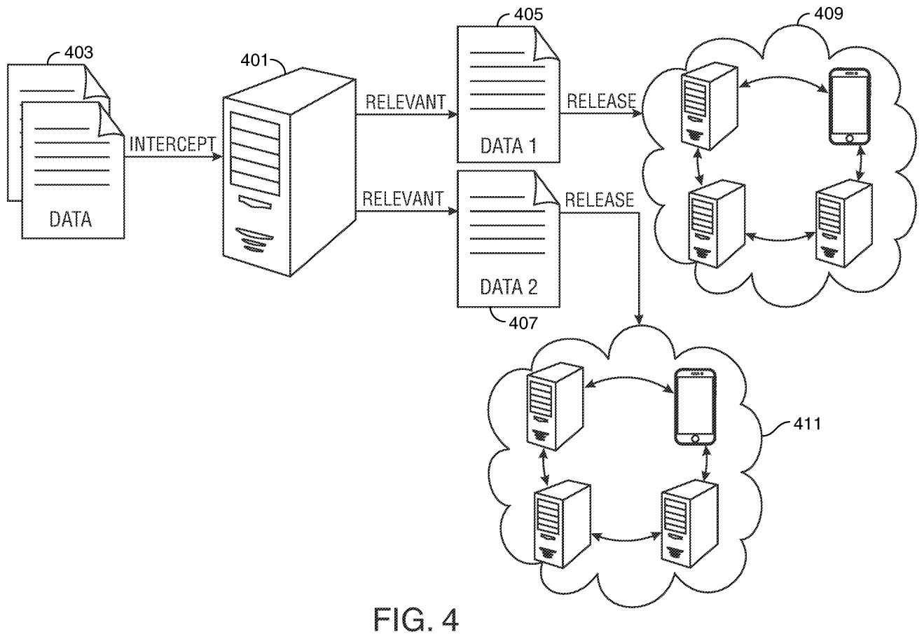

FIG. 4 shows an illustrative schematic in accordance with principles of the disclosure. Apparatus may include any of the components and systems odd-numbered 401 through 411, among other components, as well as steps labeled on FIG. 4. Steps may be performed on the apparatus shown in FIGS. 1-4, and 6 or other apparatus shown in other figures or described elsewhere.

A computer system 401 on an edge of multiple networks 409 and 411 may have an edge data filter installed. The edge data filter may intercept incoming data 403 before it reaches network 409 or network 411.

The edge data filter on computer system 401 may analyze the incoming data 403 to determine which, if any, of the incoming data 403 is relevant to the network 409 or network 411. Each network 409 or 411 may have different needs for data, so relevant data to one network may or may not be relevant to the other network.

The edge data filter may release relevant data 405 to the network 409.

The edge data filter may release relevant data 407 in the network 411. Data not relevant to either network may be stored in a database or deleted. Irrelevant data may not be released to a network or system on a network where the data is irrelevant.

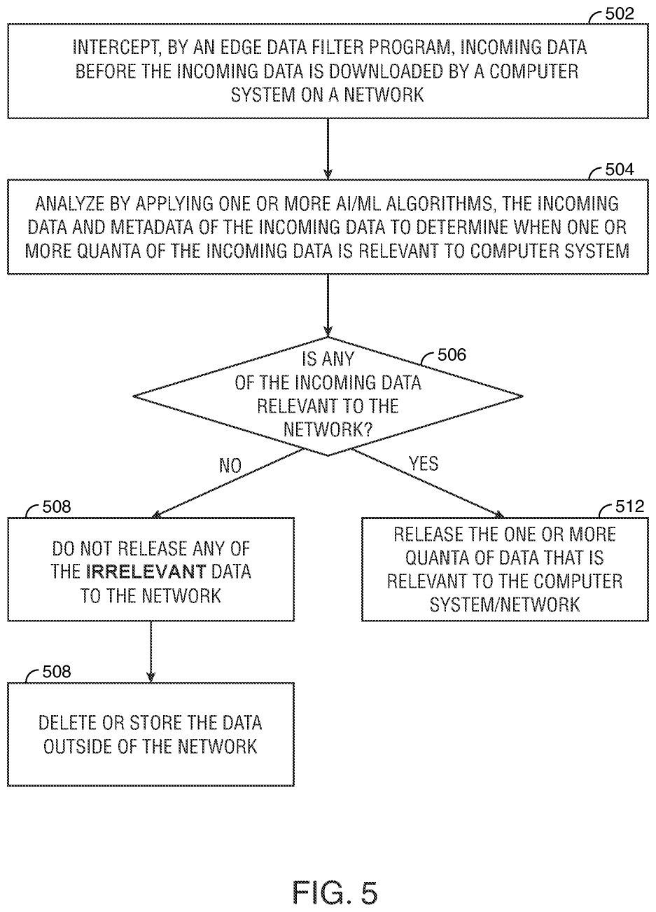

FIG. 5 shows an illustrative flowchart in accordance with principles of the disclosure. Methods may include some or all of the method steps numbered 502 through 512. Methods may include the steps illustrated in FIG. 5 in an order different from the illustrated order. The illustrative method shown in FIG. 5 may include one or more steps performed in other figures or described herein. Steps 502 through 512 may be performed on the apparatus shown in FIGS. 1-4, 6 or other apparatus.

At step 502, an edge data filter program on a centralized or decentralized server may intercept incoming data before the incoming data is downloaded by a computer system on a network. The incoming data may include two or more quanta of data. The data may or may not be relevant to the network or computer system.

At step 504, the edge data filter may analyze, by applying one or more artificial intelligence/machine learning (“AI/ML”) algorithms, the incoming data and metadata of the incoming data to determine when one or more quanta of the incoming data is relevant to the computer system or network. Relevancy may be system or network specific. Relevancy may be adjusted by an administrator. Relevancy may be adjusted automatically by the edge data filter. Relevancy determination may iterate and learn with feedback from the computer system, network, or an administrator.

At step 506, the edge data filter may determine if any of the data is relevant to the computer system or network.

At step 508, if none of the data is relevant, the edge data filter will not release any of the data to the computer system or network.

At step 510, the edge data filter may delete the irrelevant incoming data, store the irrelevant data outside of the network, or forward the irrelevant data to a different network where it may be relevant.

At step 512, if any of the data is relevant to the computer system or network, the edge data filter may release the relevant data to the computer system or network.

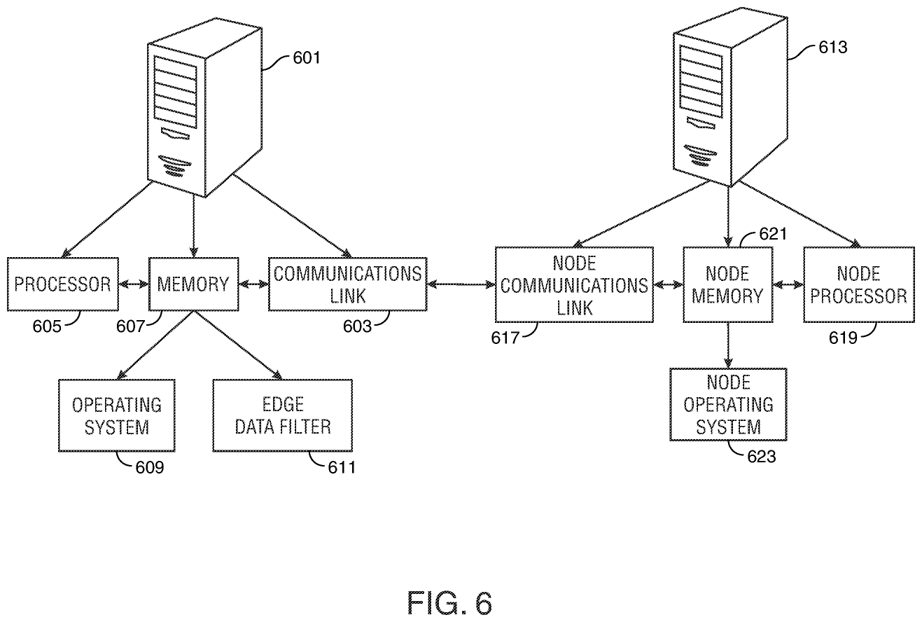

FIG. 6 shows an illustrative apparatus in accordance with principles of the disclosure. The apparatus may include a central server 601 and one or more network nodes 613.

The central server 601 may include a server communications link 603, a server processor/processors 605, and a server non-transitory memory 607, as well as other components.

Network node 613 may include a node communications link 617, a node processor or processors 619, and a node non-transitory memory 621.

The server non-transitory memory 607 may include a server operating system 609, an edge data filter application 611, as well as other data and programs.

The server communications link 603 may communicate with each node 613 (as well as other servers/computers, not shown). The edge data filter 611 may communicate with all nodes 613 through the server communications link 603.

The node non-transitory memory 621 may include a node operating system 623, as well as other applications.

The edge data filter 611 may intercept incoming data before the incoming data is downloaded by any of the one or more network nodes 613.

The edge data filter 611 may analyze, by applying one or more artificial intelligence/machine learning (“AI/ML”) algorithms, the incoming data and metadata of the incoming data to determine when one or more quanta of the incoming data is relevant to one or more network nodes 613.

When one or more quanta of data is relevant to one or more network nodes 613, the edge data filter 611 may release the one or more quanta of data that is relevant to the one or more network nodes.

Thus, apparatus and methods to automatically filter data at an edge of a network are provided. Persons skilled in the art will appreciate that the present invention can be practiced by other than the described embodiments, which are presented for purposes of illustration rather than of limitation.

What is claimed is:

1. An edge data filter computer program product, the computer program product comprising executable instructions, the executable instructions when executed by a processor on a computer system:
intercept incoming data before the incoming data is downloaded by a network, wherein the incoming data includes two or more quanta of data;
analyze the incoming data and metadata of the incoming data to determine when one or more quanta of the incoming data is relevant to the network; and
when one or more quanta of data is relevant to the network, release the one or more quanta of data that is relevant to the network;
wherein the analysis applies one or more artificial intelligence/machine learning (“AI/ML”) algorithms to determine whether the incoming data is relevant to the network.

2. The edge data filter computer program product of claim 1 wherein the instructions store the incoming data in a safe zone.

3. The edge data filter computer program product of claim 2 wherein the safe zone is outside of the network.

4. The edge data filter computer program product of claim 1 wherein the analysis analyzes a geographic origin of the incoming data.

5. The edge data filter computer program product of claim 1 wherein the analysis analyzes an originating time of the incoming data.

6. The edge data filter computer program product of claim 1 wherein the analysis analyzes a personal origin of the incoming data.

7. The edge data filter computer program product of claim 1 wherein the analysis analyzes a type of the incoming data.

8. The edge data filter computer program product of claim 1 wherein the analysis compares the incoming data to data already on the network.

9. The edge data filter computer program product of claim 1 wherein the analysis applies one or more filtering rules to determine whether the incoming data is relevant to the network, said one or more filtering rules being supplied by an administrator.

10. The edge data filter computer program product of claim 1 wherein the instructions are trained with a training set of data.

11. The edge data filter computer program product of claim 10 wherein the analysis iterates when intercepting additional incoming data.

12. The edge data filter computer program product of claim 1 wherein the analysis analyzes metadata of the incoming data to determine when one or more quanta of the incoming data is relevant to two or more networks.

13. The edge data filter computer program product of claim 12 wherein when one or more quanta of data is relevant to one or more of the two or more networks, the instructions release the one or more relevant quanta of data to the one or more of the two or more networks.

14. The edge data filter computer program product of claim 13 wherein the instructions route relevant one or more quanta of data to each network of the one or more networks.

15. The edge data filter computer program product of claim 1 wherein the instructions are configured to store all of the incoming data in a database.

16. The edge data filter computer program product of claim 1 wherein the network is an internal network.

17. The edge data filter computer program product of claim 16 wherein the internal network is configured to perform an evaluation of data received by the internal network.

18. The edge data filter computer program product of claim 2 wherein the safe zone is part of the network but is isolated from a remaining portion of the network.

19. An apparatus for an edge data filter, the apparatus comprising:
a central server, the central server including:
a server communication link;
a server processor; and
a server non-transitory memory configured to store at least:
a server operating system; and
an edge data filter; and
one or more network nodes, each network node comprising:
a node communication link;
a node processor; and
a node non-transitory memory configured to store at least a node operating system;
wherein the edge data filter:
intercepts incoming data before the incoming data is downloaded by any of the one or more network nodes;
analyzes, by applying one or more artificial intelligence/machine learning (“AI/ML”) algorithms, the incoming data and metadata of the incoming data to determine when one or more quanta of the incoming data is relevant to one or more network nodes; and
when one or more quanta of data is relevant to one or more network nodes, releases the one or more quanta of data that is relevant to the one or more network nodes.

20. A method for an edge data filter, the method comprising the steps of:
intercepting, by an edge data filter program on a central server, incoming data before the incoming data is downloaded by a computer system on a network, wherein the incoming data includes two or more quanta of data;
analyzing, by the edge data filter program applying one or more artificial intelligence/machine learning (“AI/ML”) algorithms, the incoming data and metadata of the incoming data to determine when one or more quanta of the incoming data is relevant to computer system; and
when one or more quanta of data is relevant to the computer system, releasing the one or more quanta of data that is relevant to the computer system.
